(19) United States
(12) Patent Application Publication
(10) Pub. No.: US 2008/0252087 A1
(43) Pub. Date: Oct. 16, 2008

(54) BUMPER SYSTEM

(75) Inventors: MICHAEL ROLL, Bielefeld (DE); BURKHARD ROPER, Paderborn (DE)

Correspondence Address: Henry M. Feiereisen;Henry M. Feiereisen, LLC, Suite 4714, 350 Fifth Avenue, New York, NY, 10118, US

(73) Assignee: Benteler Automobiltechnik GmbH, Paderborn (DE)

(21) Appl. No.: 12/061,988

(22) Filed: Apr. 3, 2008

(30) Foreign Application Priority Data
Apr. 13, 2007 (DE) 10 2007 017 857.5

(51) Int. Cl. B60R 19/24

(52) U.S. Cl. 293/155

(57) ABSTRACT

A bumper system of a motor vehicle includes a bumper beam for connection to a side rail. The bumper beam has a center portion and an end portion which adjoins the center portion and extends beyond the side rail. The end portion is curved or angled in a direction of the side rail and having an outer end. Positioned at the outer end of the end portion is a containment element which extends transversely to a longitudinal center plane of the motor vehicle.

### CROSS-REFERENCES TO RELATED APPLICATIONS

This application claims the priority of German Patent Application, Serial No. 10 2007 017 857.5, filed Apr. 13, 2007, pursuant to 35 U.S.C. 119(a)-(d), the content of which is incorporated herein by reference in its entirety as if fully set forth herein.

### BACKGROUND OF THE INVENTION

The present invention relates to a bumper system for a motor vehicle.

Nothing in the following discussion of the state of the art is to be construed as an admission of prior art.

Bumper systems for motor vehicles are typically arranged across the front and rear of a motor vehicle between the plastic shell of the vehicle body and the frame of the motor vehicle. To prevent damage to the vehicle body structure in the event of a crash or impact at low speed (up to 10 km/h), crash boxes are integrated to absorb energy caused by the impact and to convert the energy in deformation work. The bumper system directly affects the type of damage to a vehicle and the damage assessment. As a result, the construction of bumpers is used for categorizing vehicles in certain insurance classes. The lower the expected repair costs in the event of a collision, the better the insurance classification. Bumpers are currently tested by offset barrier crash tests, whereby in the event of a front-offset crash test the vehicle strikes a barrier that is slanted by 100, whereas in the event of an rear-offset crash, the vehicle is hit by an impact car which strikes the test vehicle at an angle of 10° in relation to the vehicle length axis. In view of the design of current vehicles, the barriers strike directly the crash boxes so that the main work, i.e. almost the entire energy, must be absorbed in these crash tests by the crash boxes.

Other crash repair tests involve the movement of a vehicle against a barrier with slight overlap of only 15% of axle width or vehicle width. This so-called bumper to bumper test demands different characteristics of the bumper beam. Bumper beams are typically curved slightly and have end portions which project beyond the side rails or crash boxes and may be curved or angled to a greater degree. In the event of slight overlap with the barrier, such as in the bumper to bumper test, it is conceivable that the barrier slides off the curved end portion of the bumper beam, as shown in FIG. 3, with the barrier designated by reference numeral 4 and the bumper beam designated by reference numeral 11. In other words, the motor vehicle may slide off the barrier. As a result, there is a risk of substantial damage to the area of the fender. Damage of this kind adversely affects the insurance classification. Current motor vehicles with rounded corner zones allow, however, only limited tolerance for designing the bumper beam. Also, a proposal to omit curved end portions altogether is not feasible because of their need to introduce the impact force into the crash boxes and side rails.

It would therefore be desirable and advantageous to provide an improved bumper system to obviate prior art shortcomings and to minimize damage costs, even at crash repair tests with a barrier overlap of 15%.

### SUMMARY OF THE INVENTION

According to one aspect of the present invention, a bumper system of a motor vehicle includes a bumper beam for connection to a side rail, wherein the bumper beam has a center portion and an end portion which adjoins the center portion and extends beyond the side rail, with the end portion being curved or angled in a direction of the side rail and having an outer end, and a containment element positioned at the outer end of the end portion and extending transversely to a longitudinal center plane of the motor vehicle.

The present invention resolves prior art problems by shaping the end portions of the bumper beam in a way that opposes unhindered sliding through formation of a containment element at the outer end of the end portion. The containment element may be a separate component which is coupled to the bumper beam, or may be made in one piece with the bumper beam. A simple configuration involves the formation of the containment element by outwardly turning the end portion.

The containment element is oriented such that the slide-off motion of the barrier is curbed, preventing the barrier to penetrate the fender zone of the motor vehicle in the event of an impact at low speed. As a result, the direction of curvature or angling of the end portion changes or is interrupted. A transverse orientation of the containment element with respect to the length axis of the motor vehicle does not necessarily imply a disposition of the containment element at a right angle to the center longitudinal axis of the motor vehicle but includes any orientation which opposes the curvature or angling of the end portion. Therefore, it is conceivable to shape the end portion on its forward side which is distal to the side rail with an S-shaped curvature which changes in a direction of a transition to the terminal containment element. The geometry of the end portions is thus instrumental to hold the barrier on the impact-proximal side, i.e. front side. Of course, it is also possible to curve the back side of the end portion in an S-shaped manner so that front and back sides extend in parallel relationship. This, however, is not necessarily required. It is only required to make the containment element resistant enough to transmit the moments introduced by the barrier into the containment element not only onto the end portions but ultimately onto the side rail which supports the bumper beam or crash boxes which are placed anteriorly of the side rails.

The containment element assumes the task to prevent unhindered sliding of the bumper beam. The containment element should have a minimum length to fulfill the task, without being excessively long. Currently preferred is a configuration of the containment element which is defined by a length, as measured in transverse direction of the motor vehicle, which length is greater by 2% than a width of the motor vehicle. The width is hereby defined between two parallel planes oriented in parallel relationship to the motor vehicle and touching the motor vehicle laterally in an area of a center transverse plane of the motor vehicle. This definition of the motor vehicle is established by the regulations for crash tests issued by RCAR (Research Council for Automobile Repairs), or IIHS (Insurance Institute for Highway Safety), or AZT (Allianz Zentrum für Technik) [Allianz Center for Engineering].

To pass this bumper to bumper test, it is advantageous when the bumpers meet. Very long bumper beams would lead to a rigid structure which would be able to transmit significant impact energy into the crash boxes, but would also increase the overall weight of the motor vehicle and thus adversely affect fuel consumption. A bumper system according to the present invention allows the use of a bumper beam which extends by at most 85% of the width of the motor vehicle. The width is defined as described above for crash tests. The width of the entire bumper beam may also be less than 80% of the width of the motor vehicle and may especially lie in a range from 75%-80%. A bumper to bumper test with a bumper beam which extends over 80% of the motor vehicle width results in a 5% overlap between bumper beam and barrier. This overlap is sufficient for a low speed test in a speed range of 5-10 km/h to effectively prevent a sliding of the barrier in soft vehicle structures, i.e. fender zone, and to limit damage.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a simplified schematic illustration of a bumper system of a motor vehicle in accordance with the present invention;

FIG. 2 is schematic illustration of a practical implementation of a bumper system according to the present invention; and

FIG. 3 is a schematic illustration of a conventional bumper system.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

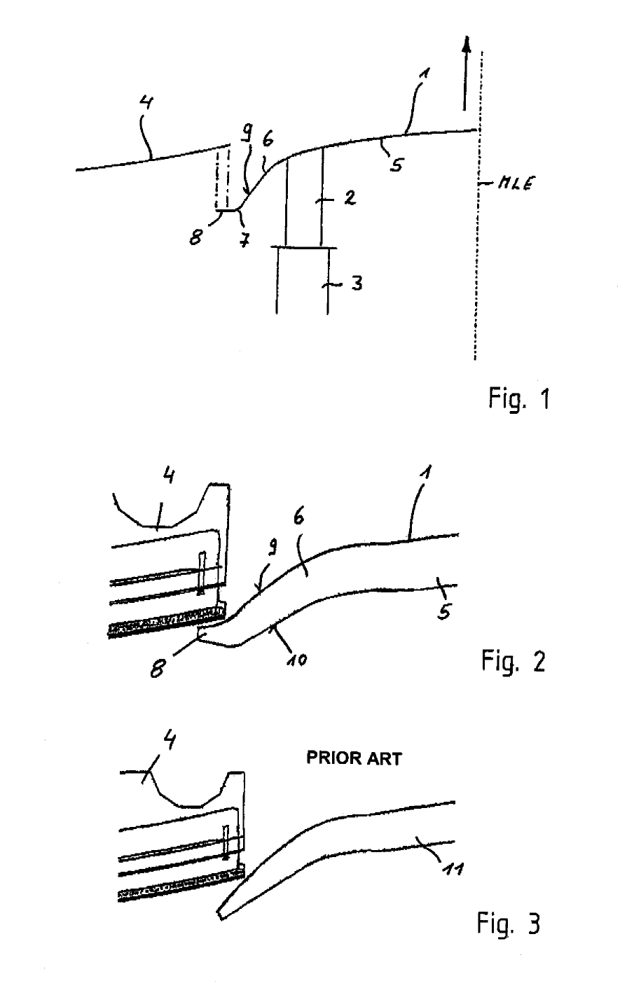

Turning now to the drawing, and in particular to FIG. 1, there is shown a simplified schematic illustration of a bumper system of an unillustrated motor vehicle in accordance with the present invention. The bumper system is configured in symmetry in relation to a longitudinal center plane MLE of the motor vehicle. FIG. 1 shows the front bumper beam 1 which is connected to a side rail via a crash box 2. Further shown is a barrier 4 which mimics the design of a bumper and is run into by the vehicle at low speed (5 km/h) at 15% overlap in relation to the width of the motor vehicle. These are standardized test conditions. The arrow indicates the travel direction.

The bumper beam 1 has a center portion 5 which extends essentially between the side rails 3 or crash boxes 2 and has a slight curvature. Adjoining the center portion 5 is an end portion 6 which projects laterally beyond the crash boxes 2 or side rails 3, as viewed in a direction transversely to the vehicle. The curvature of the end portion 6 exceeds in some areas the curvature of the center portion 5 so that the end portion is effectively angled in a direction of the side rail 3.

The end portion 6 has an outer end 7 which connects to a containment element 8 oriented transversely to the longitudinal center plane MLE of the motor vehicle and extends in this schematic illustration transversely to the longitudinal center plane MLE. The containment element 8 may be made in one piece with the bumper beam 1, e.g., by turning the outer end outwards, or may be a separate component connected to the end portion 6 by any suitable joining process.

The dashdot lines illustrate the overlap of barrier 4 and containment element 8 in the event of a crash test so that impact energy is transmitted from the containment element 8 into the end portion 6 and from there into the crash boxes 2. The orientation of the containment element 8 prevents the bumper beam 6 from sliding off the barrier 4. As can be seen in FIG. 1, the end portion 6 has a front side 9 which is distal to the side rail 3 and has S-shaped curvature. The direction of the curvature changes in a transition to the terminal containment element 8.

FIG. 2 shows a practical configuration of the bumper beam 1 to show the S-shaped curvature. The end portion 6 of the bumper beam 1 has areas of greater curvature than its center portion 5. The containment element 8 at the end portion 6 is shy of contacting the barrier 4 at an impact test with 15% overlap. As can be seen in FIG. 2, the bumper beam 1 is tapered from midsection in a direction to its containment element 8 and has a significantly smaller width in the area of the outer end 7 than in midsection. The front side 9 as well as the backside 10 of the bumper beam 1 is thus curved in an S-shaped manner, with the curvature on the backside 10 being greater than the curvature on the front side 9.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A bumper system of a motor vehicle, comprising:
a bumper beam for connection to a side rail, said bumper beam having a center portion and an end portion which adjoins the center portion and extends beyond the side rail, said end portion being curved or angled in a direction of the side rail and having an outer end; and
a containment element positioned at the outer end of the end portion and extending transversely to a longitudinal center plane of the motor vehicle.

2. The bumper system of claim 1, wherein the containment element is made in one piece with the bumper beam.

3. The bumper system of claim 1, wherein the outer end of the end portion is folded back to form the containment element.

4. The bumper system of claim 1, wherein the end portion has a forward side which is distal to the side rail and has an S-shaped curvature which changes in a direction of a transition to the terminal containment element.

5. The bumper system of claim 1, wherein the containment element is defined by a length, as measured in transverse direction of the motor vehicle, said length being greater by 2% than a width of the motor vehicle, with the width being defined between two parallel planes oriented in parallel relationship to the motor vehicle and touching the motor vehicle laterally in an area of the transverse center plane of the motor vehicle.

6. The bumper system of claim 1, wherein the bumper beam extends by at most 85% of a width of the motor vehicle, with the width being defined between two parallel planes oriented in parallel relationship to the motor vehicle and touching the motor vehicle laterally in an area of a center transverse plane of the motor vehicle.

7. The bumper system of claim 6, wherein the bumper beam extends at less than 80% of the width of the motor vehicle.

8. The bumper system of claim 6, wherein the bumper beam has an extension in a range from 75%-80% of the width of the motor vehicle.
